(19) United States
(12) Patent Application Publication
(10) Pub. No.: US 2021/0182889 A1
(43) Pub. Date: Jun. 17, 2021

(54) SYSTEM AND METHOD FOR PRICE OPTIMIZATION OF A RETAIL PORTFOLIO

(71) Applicant: Myntra Designs Private Limited, Bangalore (IN)

(72) Inventors: Sumit Borar, Bangalore (IN); Abhishek Sharma, Ajmer (IN)

(21) Appl. No.: 17/110,172

(22) Filed: Dec. 2, 2020

(30) Foreign Application Priority Data
Dec. 16, 2019 (IN) 201941052025

(51) Int. Cl. G06Q 30/02

(52) U.S. Cl. CPC G06Q 30/0206; G06Q 30/0283

(57) ABSTRACT

System and method for optimizing prices of a plurality of retail items in a portfolio are presented. The system includes a demand estimator and a price optimizer including a return computation module, a price configuration generator and a price configuration selector. The demand estimator is configured to estimate a set of demand values for the plurality of retail items at a plurality of discount levels. The return computation module is configured to compute return on investment (ROI) values for the plurality of retail items. The price configuration generator is configured to generate a plurality of price configurations for the plurality of retail items and the price configuration selector is configured to select an optimum price configuration from the plurality of price configurations based on a sales target for the portfolio.

### PRIORITY STATEMENT

The present application hereby claims priority to Indian patent application number 201941052025 filed on 16 Dec. 2019, the entire contents of which are hereby incorporated herein by reference.

### BACKGROUND

Embodiments of the description generally relate to system and method for price optimization of a retail portfolio, and more particularly to system and method for generating automated pricing plan for retail portfolio based on a given sales target.

Pricing is one of the major strategic elements of marketing and has evolved over time. Pricing directly affects the marketing mix elements such as product features, business decisions, and promotions. The way pricing strategies are utilized will have a direct effect on purchasing decisions and thus on the success of any business. In recent years, pricing of products and services being sold online has become one of the most exciting and complex aspects in e-commerce. E-retailers are provided an unprecedented visibility into customer purchase behavior and an environment in which prices can be updated quickly and economically in response to changing market conditions. Such dynamic pricing strategies are widely used for maximizing revenue in an Internet retail channel by actively learning customers' demand response to price (price elasticity) and thus providing a rich framework for pricing projects. However, such broader level insights might not lead to correct assumptions, especially in the fashion industries. For example, categorizing retail items with same elasticity in one group without considering other aspects at the granular level might not always yield the correct results. Moreover, it may be desirable to develop pricing strategy at an individual retail item/style level for an entire portfolio/catalogue while maximizing on a given sales target for the portfolio/catalogue.

Thus, there is a need for systems and methods that provide for price optimization at a retail item/style level for an entire portfolio/catalogue while maximizing on a given sales target for the portfolio/catalogue.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide systems and methods to

Briefly, according to an example embodiment, a system for optimizing prices of a plurality of retail items in a portfolio is presented. The system includes a demand estimator and a price optimizer including a return computation module, a price configuration generator and a price configuration selector. The demand estimator is configured to estimate a set of demand values for the plurality of retail items at a plurality of discount levels. The return computation module is configured to compute return on investment (ROI) values for the plurality of retail items, based on the estimated set of demand values and price attributes of the plurality of retail items. The price configuration generator is configured to generate a plurality of price configurations for the plurality of retail items, wherein a price of one or more retail items in the plurality of price configurations is selected based on the computed ROI values. The price configuration selector is configured to select an optimum price configuration from the plurality of price configurations based on a sales target for the portfolio.

According to another example embodiment, a method for optimizing prices of a plurality of retail items in a portfolio is presented. The method includes estimating a set of demand values for the plurality of retail items at a plurality of discount levels. The method further includes computing return on investment (ROI) values for the plurality of retail items, based on the estimated set of demand values and price attributes of the plurality of retail items. The method furthermore includes generating a plurality of price configurations for the plurality of retail items, wherein a price of one or more retail item in the plurality of price configurations is selected based on the estimated ROI values. Moreover, the method includes selecting an optimum price configuration from the plurality of price configurations based on a sales target for the portfolio.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating a system for optimizing prices of a plurality of retail items in a portfolio, according to some aspects of the present description,

FIG. 2 is a is a block diagram illustrating a system for optimizing prices of a plurality of retail items in a portfolio, according to some aspects of the present description,

FIG. 3 is a is a block diagram illustrating a system for optimizing prices of a plurality of retail items in a portfolio, according to some aspects of the present description,

FIG. 4 is a flow chart illustrating a method for optimizing prices of a plurality of retail items in a portfolio, according to some aspects of the present description,

FIG. 5 shows the data flow for a method step illustrated in FIG. 4, according to some aspects of the present description,

FIG. 6 shows the data flow for a method step illustrated in FIG. 4, according to some aspects of the present description,

FIG. 7 shows the data flow for a method step illustrated in FIG. 4, according to some aspects of the present description, and

FIG. 8 is a flow chart illustrating a method step shown in FIG. 4, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Example embodiments of the present description present systems and methods for price optimization of a portfolio given a particular sales target.

FIG. 1 is a block diagram of a system 100 for optimizing prices of a plurality of retail items in a portfolio. The system 100 includes a demand estimator 102 and a price optimizer 104 operatively coupled to the demand estimator 102. The price optimizer 104 further includes a return computation module 106, a price configuration generator 108, and a price configuration selector 110. The demand estimator 102 and the components of the price optimizer 104 are described in further detail below.

The term “portfolio” as used herein refers to a defined collection of retail items. Non-limiting examples of retail items include fashion retail items, furniture items, decorative items, linen, furnishing (carpets, cushions, curtains), lamps, tableware, and the like. In one embodiment, the portfolio is a collection of fashion retail items. Non-limiting examples of fashion retail items include garments (such as top wear, bottom wear, and the like), accessories (such as scarves, belts, socks, sunglasses, bags), jewellery, foot wear and the like. For the purpose of this description, the following embodiments are described with respect to an online fashion retail platform. However, it must be understood that embodiments described herein can be implemented on any e-commerce platform having a portfolio of retail items.

The portfolio may be defined based on metrics and/or organizational structure of the retailer. For example, the portfolio may be defined based on individual departments within the retail organization. In some example embodiments, the portfolio may be segregated based on the gender and categories of the fashion retail items. For example, in an example embodiment, the portfolio may include all men's top wear. In another example, the portfolio may include all women's western wear (including both top wear and bottom wear). In another example embodiment, the portfolio may include all the retail items being sold by the retailer, e.g., the entire catalogue on an online fashion retail platform.

It should be noted that the term “retail item” as used herein refers to a particular “style” of the “retail item” within the portfolio. For example, for a portfolio including all men's shirts, the term “plurality of retail items” refers to the different style of shirts (varying by brand, design, color etc.) available in the portfolio. As each retail item (e.g., a shirt) will be available at different sizes, the term “retail item” encompasses all the sizes for a particular style (e.g., shirt of a particular brand with a particular design and color). Similarly, for a portfolio including all women's wear, the term “plurality of retail items” refers to the different products, such as, bottom wear and top wear (varying by style, brand, design, color etc.) available in the portfolio.

Referring again to FIG. 1, the demand estimator 102 is configured to estimate a set of demand values 12 for the plurality of retail items at a plurality of discount levels. The term “demand value” as used herein refers to the demand of each retail item in the portfolio at a particular price point or the discount level. The demand estimator 102 includes a suitable demand prediction model, and is configured to estimate the set of demand values 12 from the demand prediction model based on input data 10 presented to the demand prediction model. In one example embodiment, the demand prediction model is a gradient boosted decision tree. The demand estimator 102 may be further configured to train the demand prediction model based on historical data.

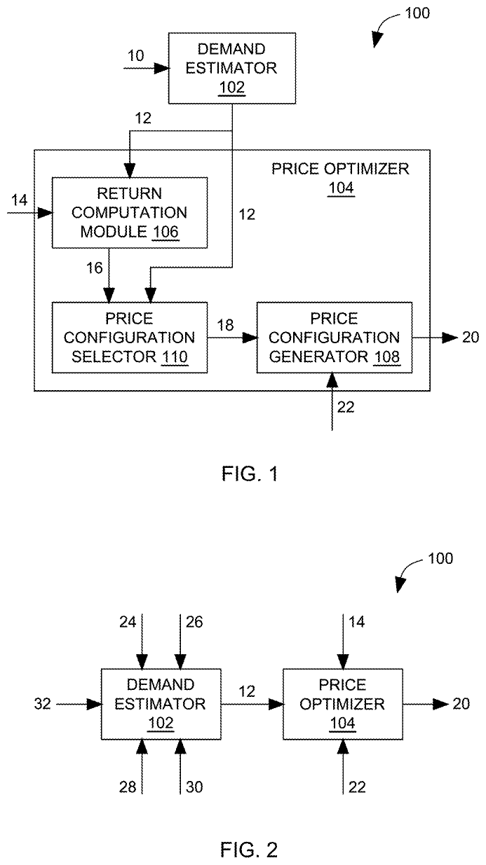

In one embodiment, as shown in FIG. 2, the demand estimator 102 is configured to estimate the set of demand values 12 based on one or more historical sales attributes 24, changes in one or more historical sales attributes 26, one or more historical inventory attributes 28, one or more competitive features 30, and one or more current features 32 of the plurality of retail items. Non-limiting examples of historical sales attributes 24 include historical data on quantities sold, average selling price, or average input discounts for the plurality of retail items. Similarly, non-limiting examples of changes in one or more historical sales attributes 26 include step change in one or more of quantities sold, average selling price, or average input discounts for the plurality of retail items. Non-limiting examples of historical inventory attributes 28 include live stock keeping unit (sku) count, non-live sku count, and the like. Competitive features 30 may include features of competing styles (e.g., aggregation on visibility, quantities sold, maximum retail price (mrp)) based on brand, day of sale, article and gender based, or relative value based. Current features 30 may include inventory and price-based features (e.g., average selling price, average input, mrp, and the like). In some embodiments, the demand estimator 102 may be further configured to estimate the set of demand values based on additional features such as traffic-based variable, age of the style, week day, and the like.

The demand estimator 102 is configured to estimate the set of demand values at a plurality of discount levels. The discount levels may be pre-defined by the retailer or an individual business unit of the retailer. In one embodiment, the demand estimator 102 is configured to estimate the set of demand values at three discount levels, such as, a default discount level (d), a first discount level (d1) that is greater than the default discount level, and a second default level (d2) that is lower than the default discount level. The term “default discount level” as used herein refers to the discount that would have been given on a particular retail item before implementation of the price optimization as described herein. In an example embodiment, the plurality of discount levels include d+5% (d1), d, and d−5% (d2).

The demand estimator 102 is operationally coupled to the return computation module 106 of the price optimizer. The return computation module 106 is configured to receive the estimated set of demand values 12 from the demand estimator 102 and further configured to compute return on investment (ROI) values 16 for the plurality of retail items, based on the estimated set of demand values 12 and price attributes 14 of the plurality of retail items. Price attributes may include the mrp and the discount level for each retail item of the plurality of retail items.

The term “return on investment value” refers to the ratio of change in revenue to the change in discount for each retail item. The return on investment (ROI) value for each retail item may be calculated using the following equation:

ROI=change in revenue/change in discount (I)

The return computation module 104 is configured to compute a set of first ROI values (ROI_{d-d1}) for the plurality of retail items for a change in discount level from the default discount level (d) to the first discount level (d1). The return computation module 104 is also configured to compute a set of second ROI values (ROI_{d2-d}) for the plurality of retail items for a change in discount level from the second default level (d2) to the default discount level (d).

The price configuration generator 108 is configured to receive the computed ROI values (ROI_{d-d1} and ROI_{d-d2}) 16 and the estimated demand values 12 from the return computation module 106 and the demand estimator 102, respectively. The price configuration generator 108 is further configured to generate a plurality of price configurations 18 for the plurality of retail items, wherein a price of one or more retail items in the plurality of price configurations 18 is selected based on the computed ROI values (ROI_{d-d1} and ROI_{d2-d}) 16.

The computed ROI values (ROI_{d-d1} and ROI_{d-d2}) 16 are used by the price configuration generator 108 to generate the plurality of price configurations 18 while limiting the number of possible configurations to a defined heuristic number. In one embodiment, the number of possible configurations 18 is limited to less than 2000. In one example embodiment, the number of possible configurations 18 is limited to 1600.

In one embodiment, the price configuration generator 108 is configured to generate a price configuration of the plurality of price configurations by: (i) selecting a price of a first set of retail items of the plurality of retail items at the first discount level (d1) if the computed first ROI value (ROI_{d-d1}) for the first set of retail items is greater than a first ROI threshold value (ROIₜ₁), (ii) selecting a price of a second set of retail items of the plurality of retail items at the default discount level (d) if the computed second ROI value (ROI_{d-d2}) for the second set of retail items is greater than a second ROI threshold value (ROIₜ₂), (iii) selecting a price of a third set of retail items of the plurality of retail items at the default discount level (d) if the estimated demand value is zero, and (iv) selecting a price of the remaining retail items of the plurality of retail items at the second discount level (d2). The price configuration generator 108 is further configured to generate the plurality of price configurations 18 by repeating steps (i) to (iv) at different first ROI threshold (ROIₜ₁) and second ROI threshold (ROIₜ₂) values. As mentioned earlier, the number of possible configurations is limited to a defined heuristic number, and therefore, the first ROI threshold (ROIₜ₁) and second ROI threshold (ROIₜ₂) values are varied until the number of desired configurations is reached.

With continued reference to FIG. 1, the price configuration selector 110 is configured to select an optimum price configuration 20 from the plurality of price configurations 18 based on a sales target 22 for the portfolio. The sales target 22 may be provided by the retailer or an individual business unit of the retailer. The sales target 22 for the portfolio may include a revenue target for the portfolio, a gain margin target for the portfolio, or both.

In one embodiment, the price configuration selector 110 is configured to select a price configuration as the optimum price configuration 20 if an estimated revenue for the selected price configuration is equal to or greater than the revenue target for the portfolio and an estimated gain margin for the selected price configuration is equal to or greater than the gain margin target for the portfolio.

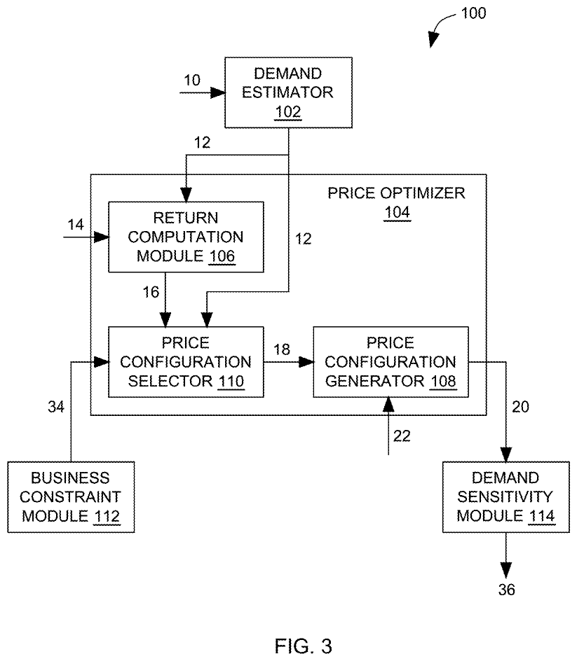

Referring now to FIG. 3, the system 100 may further include a business constraint module 112 configured to provide one or more business constraints 34 as inputs to the price configuration generator 108. Non-limiting examples of business constraints include inventory-based constraints, constraints on discount levels for certain brands, or constraints on discount levels for certain retail items/styles.

With continued reference to FIG. 3, the system 100 may further include a demand sensitivity module 114 configured to estimate a demand sensitivity 36 for the plurality of retail items based on the selected optimum price configuration 20. The demand sensitivity 36 may include demand elasticity, which is a measure of the change in quantity demanded in related to its price change. The demand elasticity may be estimated as the ratio of % change in quantity demanded to the % change in price.

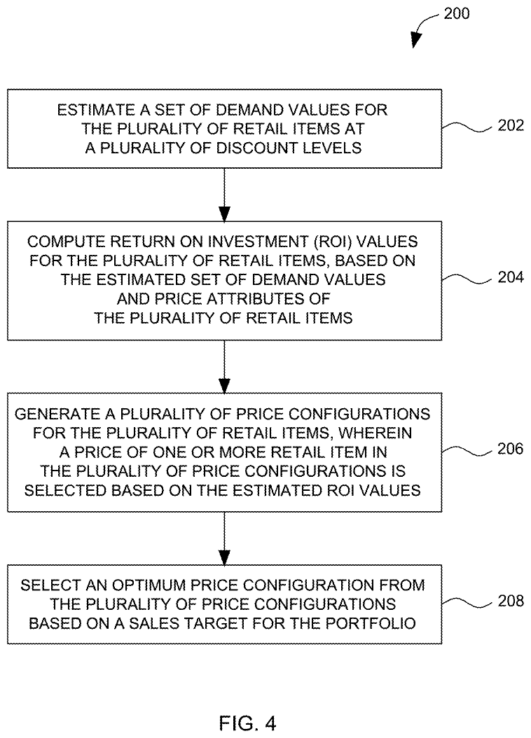

The manner of implementation of the system 100 of FIGS. 1-3 is described below in FIGS. 4-8.

FIG. 4 is a flowchart illustrating a method 200 for optimizing prices of a plurality of retail items in a portfolio. The method 200 may be implemented using the systems of FIGS. 1-3, according to some aspects of the present description. Each step of the method 200 is described in detail below.

The method 200 includes, at step 202, estimating a set of demand values for the plurality of retail items at a plurality of discount levels. The set of demand values are estimated using a suitable demand prediction model. The method 200 may further include training the demand prediction model based on historical data. In one embodiment, the method 200 may further include generating simulated data, based on historical data and appropriate scaling factors, before providing the input data to the demand prediction model.

In one embodiment, the set of demand values 12 may be estimated based on one or more historical sales attributes 24, changes in one or more historical sales attributes 26, one or more historical inventory attributes 28, one or more competitive features 30, and one or more current features 32 of the plurality of retail items. Non-limiting examples of historical sales attributes 24 include historical data on quantities sold, average selling price, or average input discounts for the plurality of retail items. Similarly, non-limiting examples of changes in one or more historical sales attributes 26 include step change in one or more of quantities sold, average selling price, or average input discounts for the plurality of retail items. Non-limiting examples of historical inventory attributes 28 include live sku count, non-live sku count, and the like. Competitive features 30 may include features of competing styles (e.g., aggregation on visibility, quantities sold, maximum retail price (mrp)) based on brand, day of sale, article and gender based, or relative value based. Current features 30 may include inventory and price-based features (e.g., average selling price, average input, mrp, and the like). In some embodiments, the method 200 may further include estimating the set of demand values 12 based on additional features such as traffic-based variable, age of the style, week day, and the like.

The discount levels may be pre-defined by the retailer or an individual business unit of the retailer. In one embodiment, the method 200 includes estimating the set of demand values at three discount levels, such as, a default discount level (d), a first discount level (d1) that is greater than the default discount level, and a second default level (d) that is lower than the default discount level. In an example embodiment, the plurality of discount levels include d+5%, d, and d−5%, that is, the default discount level and ±5% of the default discount level.

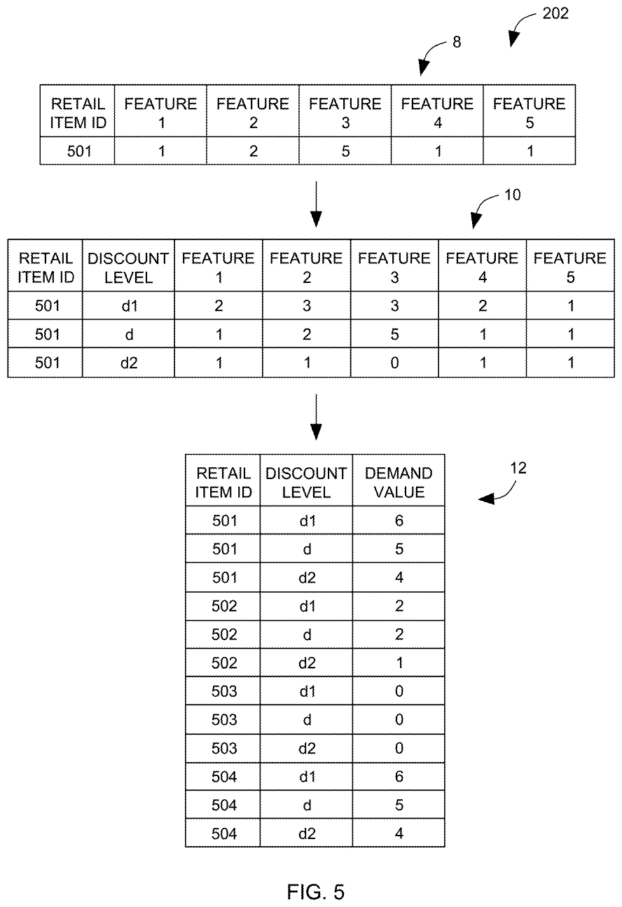

FIG. 5 illustrates the data flow, for step 202 of FIG. 4, according to an example embodiment of the present description. As shown in FIG. 5, for a retail item identified by ID 501, the method first includes simulating data at three different discount levels d1, d, and d2 vis-á-vis different features, as described earlier, to generate input data 10. The input data 10 may be generated based on historical data 8. In the example embodiment illustrated in FIG. 5, d1 is d+5% and d2 is d−5%. It should be noted that the number of features is limited to five for illustration purposes only, and the actual number of features will vary depending on the demand prediction model used. In some embodiments, the number of features may be greater than 90. The input data may be simulated for all the retail items in the portfolio. Further, the input data 10 is presented to a demand prediction model (e.g., in a demand estimator 102 of FIG. 1) to estimate the set of demand values 12 at the three demand levels d1, d, and d2. FIG. 5 shows the estimated demand values for four retails items (501, 502, 503 and 504) at the three discount levels as an example embodiment. Similarly, the demand values 12 may be estimated for the rest of the retail items in the portfolio.

Referring back to FIG. 4, the method 200 further includes, at step 204, computing return on investment (ROI) values for the plurality of retail items, based on the estimated set of demand values 12 and price attributes 14 of the plurality of retail items. Price attributes 14 may include the mrp and the discount level for each retail item of the plurality of retail items. As noted earlier, the ROI value for each retail item may be calculated using the following equation:

ROI=change in revenue/change in discount (I)

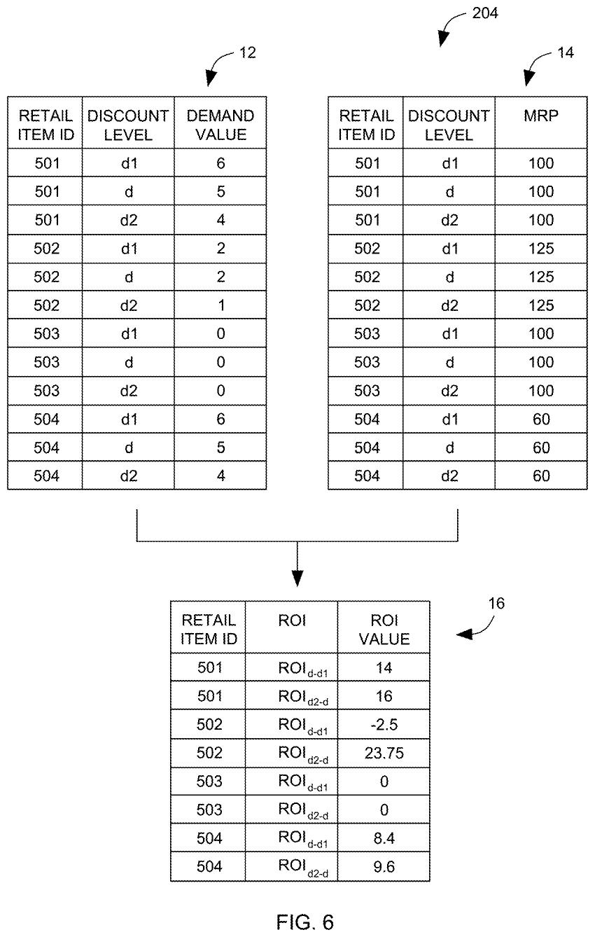

Step 204 includes computing a set of first ROI values (ROI_{d-d1}) for the plurality of retail items for a change in discount level from the default discount level (d) to the first discount level (d1). Step 204 further includes computing a set of second ROI values (ROI_{d2-d}) for the plurality of retail items for a change in discount level from the second default level (d2) to the default discount level (d). FIG. 6 shows the data flow in step 204, based on the data generated in step 202 (FIG. 5). As shown in FIG. 6, for the four retail items 501-504, the two sets of ROI values 16 are computed based on the estimated demand values 12 and the price attributes 14. Similarly, the ROI values 16 may be computed for the rest of the retail items in the portfolio.

The method 200 further includes, at step 206, generate a plurality of price configurations 18 for the plurality of retail items, wherein a price of one or more retail items in the plurality of price configurations 18 is selected based on the computed ROI values (ROI_{d-d1} and ROI_{d2-d}) 16. The term “price configuration” as used herein refers to the selection of discount level and the corresponding selling price for each retail item in the portfolio. The price configuration may further include additional attributes of the retail items, such as, the mrp and the estimated demand value for the selected discount level. As will be apparent to one of ordinary skill in the art, for a portfolio of large number of retail items, the number of such possible configurations would be infinite.

The method 200, in accordance with embodiments of the present description, provides for a methodology to limit the number of possible configurations to a manageable number, which is a defined heuristic number. In one embodiment, the number of possible configurations 18 is limited to less than 2000. In one example embodiment, the number of possible configurations 18 is limited to 1600.

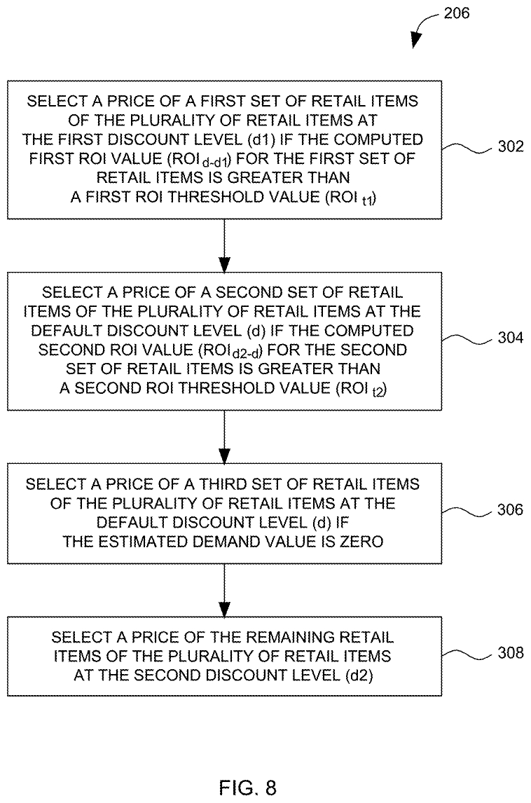

According to embodiments of the present description, the number of possible configurations is limited to a defined heuristic number by moving from the highest revenue point (by increasing discount for all retail items) to the highest margin point (by decreasing discount for all retail items). This is further illustrated in FIG. 8. As shown in FIG. 8, the step 206 includes generating a price configuration of the plurality of price configurations by: (i) selecting a price of a first set of retail items of the plurality of retail items at the first discount level (d1) if the computed first ROI value (ROI_{d-d1}) for the first set of retail items is greater than a first ROI threshold value (ROIₜ₁) (step 302), (ii) selecting a price of a second set of retail items of the plurality of retail items at the default discount level (d) if the computed second ROI value (ROI_{d2-d}) for the second set of retail items is greater than a second ROI threshold value (ROIₜ₂) (step 304), (iii) selecting a price of a third set of retail items of the plurality of retail items at the default discount level (d) if the estimated demand value is zero (step 306), and (iv) selecting a price of the remaining retail items of the plurality of retail items at the second discount level (d2) (step 308).

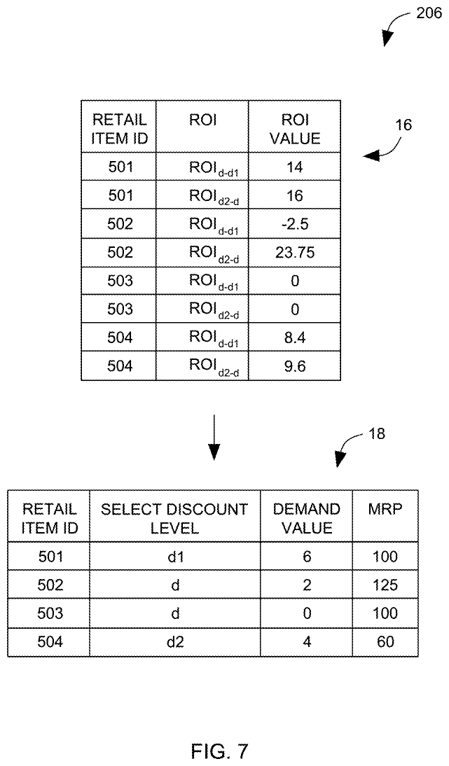

FIG. 7 illustrates the methodology for generating a price configuration 18 based on the ROI values computed in FIG. 6, according to an example embodiment of the present description. In the example embodiment illustrated in FIG. 7, the first ROI threshold value (ROM) is defined as 10 and the second ROI threshold value (ROIₜ₂) is defined as 20. As mentioned earlier, the first and second ROI threshold values may be predefined and may be varied to generate the plurality of price configurations.

As shown in FIG. 7, according to step 302 of FIG. 8, only the price of retail item 501 is selected at the first discount level d1, as only the ROI_{d-d1} value for the retail item 501 is greater than 10, which is the defined ROₜ₁. The ROI_{d-d1} values for the remaining retail items 502-504 are all less than 10. Further, according to step 304 of FIG. 8, out of the remaining retail items 502-504, the price of retail item 502 is selected at the default discount level d, as only the ROI_{d-d2} value for the retail item 502 is greater than 20, which is ROIₜ₂. Moreover, the price of the retail item 503 is also selected as default discount level d, as the estimated demand value is 0 (step 306 of FIG. 8). Finally, the price of the remaining retail item 504 is selected as the second discount level d2 (step 308 of FIG. 8). Therefore, a price configuration 18 including the selected discount levels, the corresponding demand values, and the mrp is generated for the plurality of retail items.

The step 206 further includes repeating steps 302-308 as shown in FIG. 8, at different first ROI threshold (ROIₜ₁) and second ROI threshold (ROIₜ₂) values. As mentioned earlier, the number of possible configurations is limited to a defined heuristic number, and therefore, the first ROI threshold (ROIₜ₁) and second ROI threshold (ROIₜ₂) values are varied until the number of desired configurations is reached.

In some embodiments, step 206 may further include factoring in one or more business constraints before generating the plurality of price configurations 18. Non-limiting examples of business constraints include inventory-based constraints, constraints on discount levels for certain brands, or constraints on discount levels for certain retail items.

Referring back to FIG. 4, the method 200 further includes, at step 208, selecting an optimum price configuration 20 from the plurality of price configurations 18 based on a sales target 22 for the portfolio. The sales target 22 may be provided by the retailer or an individual business unit of the retailer. The sales target 22 for the portfolio may include a revenue target for the portfolio, a gain margin target for the portfolio, or both.

In one embodiment, step 208 includes selecting a price configuration as the optimum price configuration 20 if an estimated revenue for the selected price configuration is equal to or greater than the revenue target for the portfolio and an estimated gain margin for the selected price configuration is equal to or greater than the gain margin target for the portfolio. In such embodiments, step 208 includes calculating the revenue and gain margin for each price configuration of the plurality of price configurations until the revenue and gain margin targets are met. The configuration at which the targets are met is selected as the optimum price configuration, thereby providing the optimum price point for each retail item in the portfolio while meeting the revenue and gain margin targets.

In some embodiments, the method 200 may further include estimating the demand sensitivity of the plurality of retail items based on the optimized price configuration. The demand sensitivity may include demand elasticity, which is a measure of the change in quantity demanded in related to its price change. For example, in the optimized price configuration, the retail items with higher discounts would be highly elastic. The highly elastic retail items would have a higher ROI and would drive higher revenue. Similarly, the retail items with lower discounts would be highly inelastic meaning and not discount sensitive, i.e., their demand would not change by a lot even when their prices have been increased. The highly inelastic retail items would drive higher margins.

The system(s), described herein, may be realized by hardware elements, software elements and/or combinations thereof. For example, the modules and components illustrated in the example embodiments may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Embodiments of the present description provide for systems and methods for generating automated pricing plan for an entire portfolio based on historical sales data while optimizing sales target, such as revenue, margin, or both. Further, the systems and methods of the present description provide optimized price, revenue and margin estimates at a retail item/style level. Accordingly, revenue and margin goals can be targeted on a day to day basis, giving better control over meeting revenue and margin targets. The systems and methods in accordance with some embodiments of present description also factor in the effect of competitive styles as the price change for one style could affect the demand and price of all other competing styles. Moreover, systems and methods according to embodiments of the present description may further provide detailed understanding of price-demand elasticity at a style level. Therefore, it may be easy to identify non performing styles and their demand could be estimated at different price points. Hence stock clearance and date of holding could be optimized.

While only certain features of several embodiments have been illustrated, and described herein, many modifications and changes will occur to those skilled in the art. It is, therefore, to be understood that the appended claims are intended to cover all such modifications and changes as fall within the scope of the invention and the appended claims.

1. A system for optimizing prices of a plurality of retail items in a portfolio, the system comprising:
a demand estimator configured to estimate a set of demand values for the plurality of retail items at a plurality of discount levels; and
a price optimizer comprising:
a return computation module configured to compute return on investment (ROI) values for the plurality of retail items, based on the estimated set of demand values and price attributes of the plurality of retail items;
a price configuration generator configured to generate a plurality of price configurations for the plurality of retail items, wherein a price of one or more retail items in the plurality of price configurations is selected based on the computed ROI values; and
a price configuration selector configured to select an optimum price configuration from the plurality of price configurations based on a sales target for the portfolio.

2. The system of claim 1, wherein the demand estimator is configured to estimate the set of demand values based on one or more historical sales attributes, changes in one or more historical sales attributes, one or more competitive features, and one or more current features of the plurality of retail items.

3. The system of claim 1, wherein the plurality of discount levels comprises a default discount level, a first discount level that is greater than the default discount level, and a second default level that is lower than the default discount level.

4. The system of claim 3, wherein the return computation module is configured to compute a set of first ROI values for a change in discount level from the default discount level to the first discount level, and a set of second ROI values for a change in discount level from the second default level to the default discount level.

5. The system of claim 4, wherein the price configuration generator is configured to generate a price configuration of the plurality of price configurations by:
(i) selecting a price of a first set of retail items of the plurality of retail items at the first discount level if the computed first ROI value for the first set of retail items is greater than a first ROI threshold value,
(ii) selecting a price of a second set of retail items of the plurality of retail items at the default discount level if the computed second ROI value for the second set of retail items is greater than a second ROI threshold value,
(iii) selecting a price of a third set of retail items of the plurality of retail items at the default discount level if the estimated demand value is zero, and
(iv) selecting a price of the remaining retail items of the plurality of retail items at the second discount level.

6. The system of claim 5, wherein the price configuration generator is further configured to generate the plurality of price configurations by repeating steps (i) to (iv) at different first ROI threshold and second ROI threshold values.

7. The system of claim 1, wherein the sales target for the portfolio comprises a revenue target for the portfolio, a gain margin target for the portfolio, or both.

8. The system of claim 7, wherein the price configuration selector is configured to select a price configuration as the optimum price configuration if an estimated revenue for the selected price configuration is equal to or greater than the revenue target for the portfolio and an estimated gain margin for the selected price configuration is equal to or greater than the gain margin target for the portfolio.

9. The system of claim 1, further comprising a business constraint module configured to provide one or more business constraints as inputs to the price configuration generator.

10. The system of claim 1, further comprising a demand sensitivity module configured to estimate a demand sensitivity for the plurality of retail items based on the selected optimum price configuration.

11. A method for optimizing prices of a plurality of retail items in a portfolio, the method comprising:
estimating a set of demand values for the plurality of retail items at a plurality of discount levels;
computing return on investment (ROI) values for the plurality of retail items, based on the estimated set of demand values and price attributes of the plurality of retail items;
generating a plurality of price configurations for the plurality of retail items, wherein a price of one or more retail item in the plurality of price configurations is selected based on the estimated ROI values; and
selecting an optimum price configuration from the plurality of price configurations based on a sales target for the portfolio.

12. The method of claim 11, wherein the set of demand values are estimated based on one or more historical sales attributes, changes in one or more historical sales attributes, one or more competitive features, and one or more current features of the plurality of retail items.

13. The method of claim 11, wherein the plurality of discount levels comprises a default discount level, a first discount level that is greater than the default discount level, and a second default level that is lower than the default discount level.

14. The method of claim 13, comprising computing a set of first ROI values for a change in discount level from the default discount level to the first discount level, and computing a set of second ROI values for a change in discount level from the second default level to the default discount level.

15. The method of claim 14, comprising generating a price configuration of the plurality of price configurations by:
(i) selecting a price of a first set of retail items of the plurality of retail items at the first discount level if the computed first ROI value for the first set of retail items is greater than a first ROI threshold value,
(ii) selecting a price of a second set of retail items of the plurality of retail items at the default discount level if the computed second ROI value for the second set of retail items is greater than a second ROI threshold value,
(iii) selecting a price of a third set of retail items of the plurality of retail items at the default discount level if the estimated demand value is zero, and
(iv) selecting a price of the remaining retail items of the plurality of retail items at the second discount level.

16. The method of claim 15, further comprising generating the plurality of price configurations by repeating steps (i) to (iv) at different first ROI threshold and second ROI threshold values.

17. The method of claim 11, wherein the sales target for the portfolio comprises a revenue target for the portfolio, a gain margin target for the portfolio, or both.

18. The method of claim 17, comprising selecting a price configuration as the optimum price configuration if an estimated revenue for the selected price configuration is equal to or greater than the revenue target for the portfolio and an estimated gain margin for the selected price configuration is equal to or greater than the gain margin target for the portfolio.

19. The method of claim 11, wherein the plurality of price configurations is generated by factoring in one or more business constraints.

20. The method of claim 11, further comprising estimating a demand sensitivity for the plurality of retail items based on the selected optimum price configuration.
